(19) United States
(12) Patent Application Publication
(10) Pub. No.: US 2007/0273789 A1
(43) Pub. Date: Nov. 29, 2007

(54) Pull-down signal detecting apparatus and pull-down signal detecting method and progressive scan converting apparatus and progressive scan converting method

(75) Inventors: Hideaki Tokutomi, Tokyo (JP); Himio Yamauchi, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/709,831

(22) Filed: Feb. 23, 2007

(30) Foreign Application Priority Data
Mar. 31, 2006 (JP) P2006-098392

(51) Int. Cl. H04N 7/01

(52) U.S. Cl. 348/449; 348/441; 348/E07.003

(57) ABSTRACT

According to one embodiment, a pull-down signal detecting apparatus judges whether an input video signal is a pull-down signal or not based on a first unit moving area number obtained in a small area unit for a first high correlation field having a high inter-field correlation between a current field signal and a one-field delay signal, or a second unit moving area number obtained in a small area unit for a second high correlation field having a high inter-frame correlation between the current field signal and a two-field delay signal.

### CROSS-REFERENCE TO RELATED APPLICATIONS

This application is based upon and claims the benefit of priority from Japanese Patent Application No. 2006-98392, filed Mar. 31, 2006, the entire contents of which are incorporated herein by reference.

### BACKGROUND

1. Field

One embodiment of the invention relates to a pull-down signal detecting apparatus and pull-down signal detecting method for detecting a pull-down signal of a cinema or the like generated by means of 2-3 pull-down scheme, and a progressive scan converting apparatus using the apparatus.

2. Description of the Related Art

In a video signal of a standard television scheme such as NTSC scheme used generally for television broadcast wave, a video is scanned by means of interlace scanning scheme.

Meanwhile, in recent years, thin-type television receivers such as liquid crystal display devices and plasma display devices are becoming popular. When such a display device is used to display a video signal of the interlace scanning scheme as it is via each scanning line, luminance of the screen significantly decreases and a video that is not good for viewing is displayed. Accordingly, in such a display device, a video is displayed by means of progressive scanning scheme. Further, when a video signal of interlace scanning scheme is displayed on a display device of the progressive scanning scheme such as a liquid crystal display device or a plasma display device, an interlace scan/progressive scan converting circuit is necessary.

Incidentally, video signals of the NTSC scheme or the like may include a video signal that is generated based on a cinema film. A cinema film has 24 frames per second, whereas the video signal of the standard television scheme is a video signal of interlace scanning scheme having 30 frames per second (60 fields per second). Therefore, the video signal generated based on a cinema film is converted to the video signal of the standard television scheme by means of 2-3 pull-down scheme or 2-2 pull-down scheme. Such a video signal of the interlace scanning scheme obtained by converting a video signal generated based on a cinema film by means of the 2-3 pull-down scheme or the like will be hereinafter referred to as a “pull-down signal”.

When this pull-down signal is generated, for example with the 2-3 pull-down scheme, first a cinema film is scanned to generate a video signal of progressive scanning scheme with a frame frequency of 24 Hz. Next, conversion is performed such that a first frame of the cinema film corresponds to first and second fields (two fields), a second frame to third to fifth fields (three fields), a third frame to sixth and seventh fields (two fields), and a fourth frame to eighth to tenth field (three fields). Since a pull-down signal by means of the 2-3 pull-down scheme is generated by such conversion, it is a signal in which odd fields and even fields are repeated alternately (arrangement of fields constituting the pull-down signal is called a pull-down sequence). Incidentally, when converted into three fields, a last field (fifth field, tenth field, or the like) is repetition of a field of the same video as a first field (third field, eighth field, or the like).

Thus, two frames of a cinema film correspond to five fields of a video signal of the standard television scheme, and a pull-down signal is generated by conversion into a video signal which is alternate repetition of a two-field video signal and a three-field video signal corresponding to frames of a cinema film. In Japanese Patent Application Publication(KOKAI) No. 2002-290927 (hereinafter referred to as patent document 1), a technique is disclosed which relates to such a pull-down signal and uses a current field signal, a one-field delay signal and a two-field delay signal to judge a film mode to detect a pull-down signal of the 2-3 pull-down scheme.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of a progressive scan converting circuit according to an embodiment of the present invention;

FIG. 2 is an exemplary block diagram showing the configuration of a pull-down signal detecting circuit according to the embodiment of the present invention;

FIG. 3 is an exemplary view showing a current field signal, a one-field delay signal, a two-field delay signal, a progressive scan converting signal, and so forth when a pull-down signal is switched to a normal video signal in a fifth field in the progressive scan converting circuit according to the embodiment of the present invention;

FIG. 4 is an exemplary flowchart showing an operation procedure of a pull-down signal judgment circuit shown in FIG. 2; and

FIG. 5 is an exemplary flowchart showing an operation procedure similarly.

### DETAILED DESCRIPTION

Various embodiments according to the invention will be described hereinafter with reference to the accompanying drawings. In general, according to one embodiment of the invention, a pull-down signal detecting apparatus judges whether an input video signal is a pull-down signal or not based on a first unit moving area number obtained in a small area unit for a first high correlation field having a high inter-field correlation between a current field signal and a one-field delay signal, or a second unit moving area number obtained in a small area unit for a second high correlation field having a high inter-frame correlation between the current field signal and a two-field delay signal.

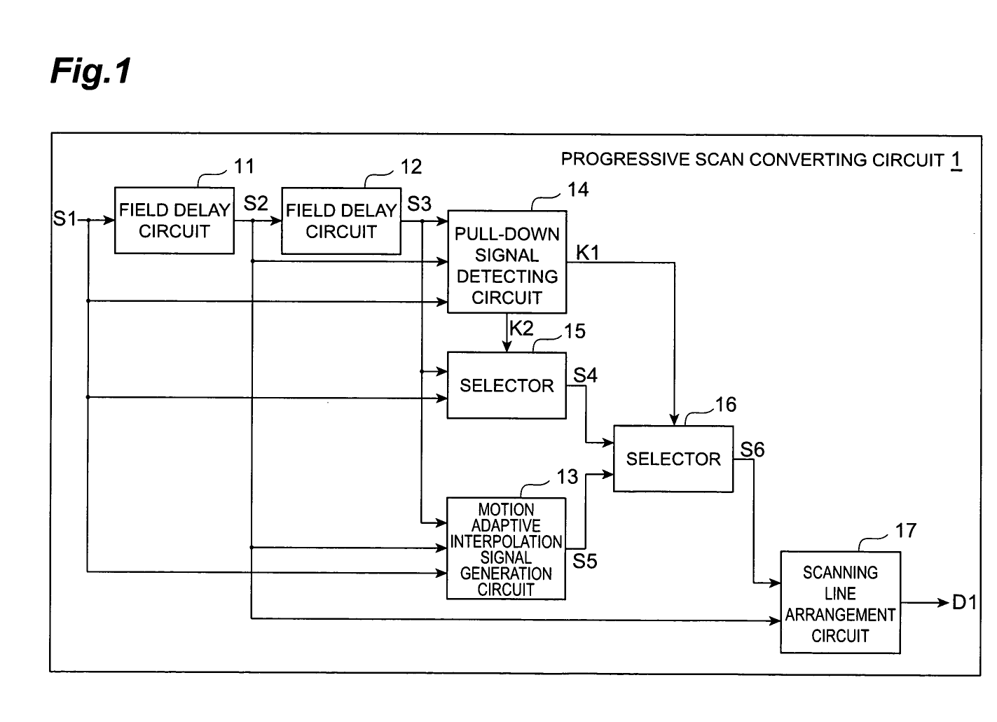

FIG. 1 is a block diagram showing the configuration of a progressive scan converting circuit 1 according to the embodiment of the present invention. As shown in FIG. 1, in the progressive scan converting circuit 1, a current field signal S1 that is an input video signal for interlace scanning is inputted to a first field delay circuit 11 and read as a one-field delay signal S2 after one field. The field delay circuit 11 has two memory areas for example, each being the size of one field, and an input video signal of one field is recorded in the two memory areas alternately. Reading of a recorded video signal is performed alternately from the two memory areas. Therefore, while the recorded current field signal S1 is read as the one-field delay signal S2 from the first field delay circuit 11, a next field signal is recorded in a memory area of the first field delay circuit 11 as the current field signal S1. Further, the one-field delay signal S2 is inputted to a second field delay circuit 12, and read as a two-field delay signal S3 after one field. The configuration and operation of the second field delay circuit 12 are the same as those of the first field delay circuit 11.

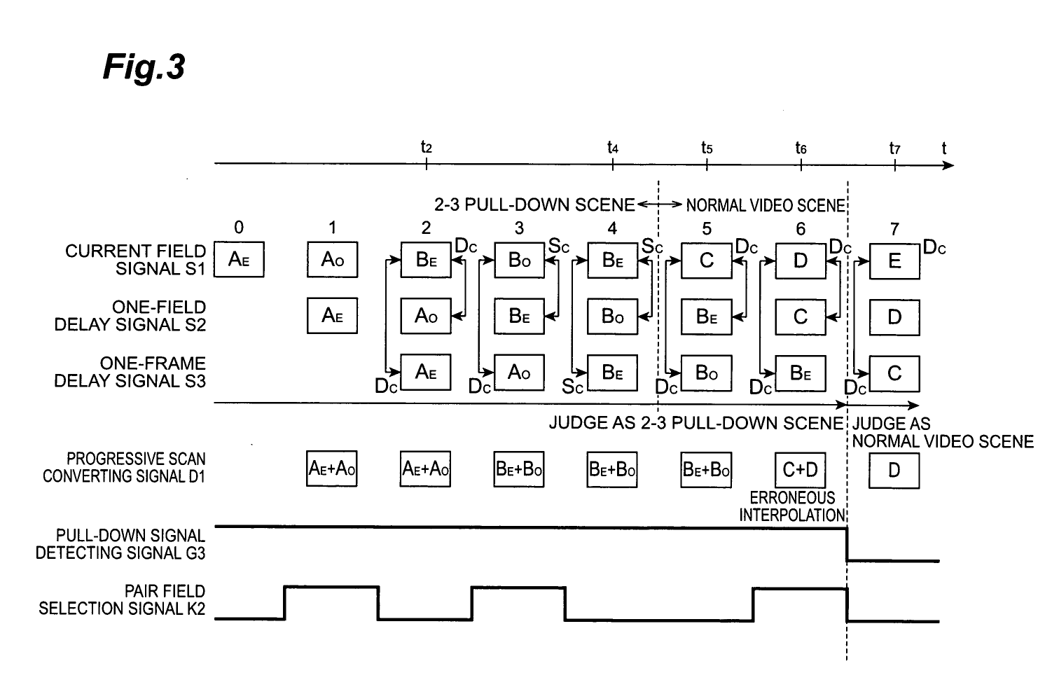

FIG. 3 shows sequentially the current field signal S1, the one-field delay signal S2 and the two-field delay signal S3 which are inputted to the progressive scan converting circuit 1. Further, FIG. 3 shows a progressive scan converting signal D1, a screen unit pull-down signal detecting signal G3 and a pair field selection signal K2, which will be described later.

In FIG. 3, A_{E} denotes an even field generated based on a frame A of a cinema film, and Ao denotes an odd field generated based on the frame A of the cinema film. B_{E} denotes an even field generated based on a frame B of the cinema film, and Bo denotes an odd field generated based on the frame B of the cinema film. C, D, E denote fields of a normal video signal.

Returning to the explanation of FIG. 1, a motion adaptive interpolation signal generation circuit 13 generates from the current field signal S1, the one-field delay signal S2, and the two-field delay signal S3 a motion adaptive interpolation signal S5 (first interpolation signal) to be located between lines of the one-field delay signal S2 by means of motion compensation interpolation with a motion vector for example.

A pull-down signal detecting circuit 14 uses the current field signal S1, the one-field delay signal S2, and the two-field delay signal S3 to judge whether an input video signal is a pull-down signal or not, and outputs a pull-down signal detection signal K1 and a pair-field selection signal K2. The pull-down signal detection signal K1 indicates whether an input video signal is a pull-down signal or not. Further, the pair-field selection signal K2 indicates which of the current field signal S1 and the two-field delay signal S3 is the field to be paired with the one-field delay signal S2. This pull-down signal detecting circuit 14 will be described in detail later.

A first selector 15 selects one of the current field signal S1 and the two-field delay signal S3 as the field to be paired with the one-field delay signal S2 according to the pair field selection signal K2, and outputs the selected signal as a pair field signal S4 to a second selector 16. The second selector 16 selects the pair field signal S4 when the pull-down signal detection signal K1 indicates a pull-down signal or otherwise selects the motion adaptive interpolation signal S5 to output the selected signal as an interpolation signal S6 (second interpolation signal). A scanning line arrangement circuit 17 arranges (combines) the one-field delay signal S2 as a direct signal and the interpolation signal S6 in the order of progressive scanning to output a progressive scan converting signal D1.

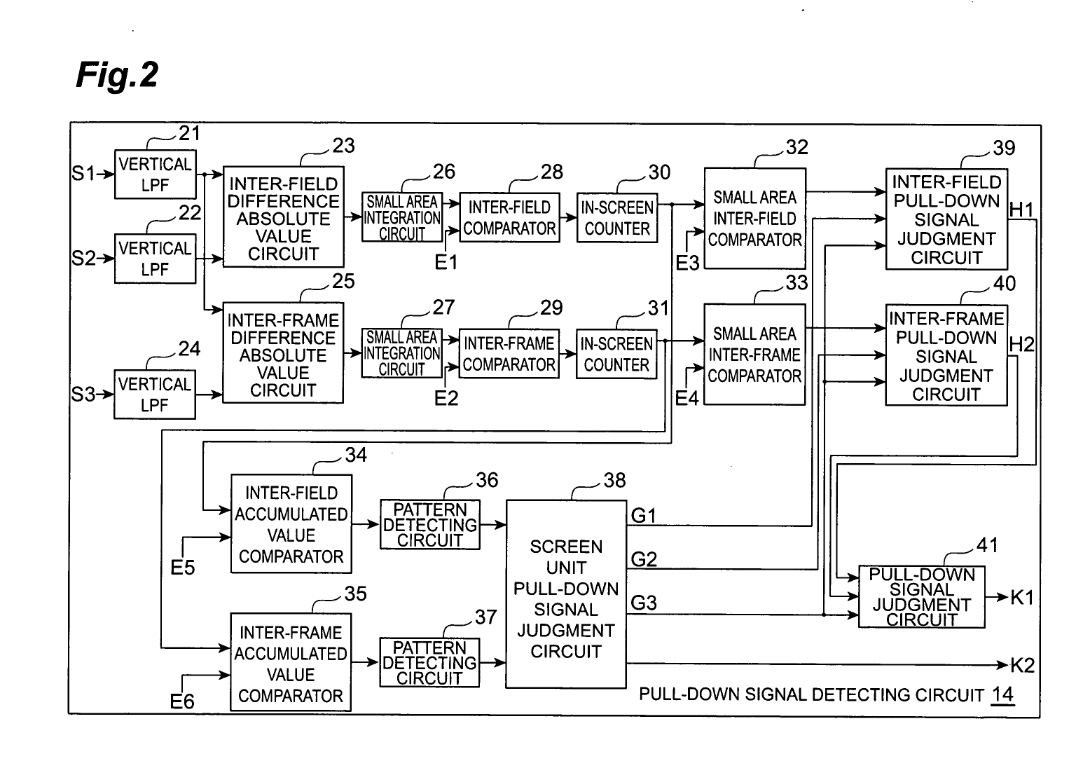

FIG. 2 is a block diagram showing the configuration of the pull-down signal detecting circuit 14 according to the embodiment of the present invention. As shown in FIG. 2, in the pull-down signal detecting circuit 14, the current field signal S1 is inputted to an inter-field difference absolute value circuit 23 and an inter-frame difference absolute value circuit 25 after passing through a first vertical LPF 21. Further, the one-field delay signal S2 is inputted to the inter-field difference absolute value circuit 23 after passing through a second vertical LPF 22. Furthermore, the two-field delay signal S3 is inputted to the inter-frame difference absolute value circuit 25 after passing through a third vertical LPF 24.

The inter-field difference absolute value circuit 23 constitutes together with a small area integration circuit 26 a first difference value calculating device according to the present invention, which calculates an inter-field difference absolute value between respective fields for the current field signal S1 and the one-field delay signal S2. The difference absolute value calculated here is used for obtaining an inter-field correlation between the current field signal S1 and the one-field delay signal S2. An output of the inter-field difference absolute value circuit 23 is inputted to the small area integration circuit 26.

The inter-frame difference absolute value circuit 25 constitutes together with a small area integration circuit 27 a second difference value calculating device according to the present invention, which calculates an inter-frame difference absolute value between respective fields for the current field signal S1 and the two-field delay signal S3. The difference absolute value calculated here is used for obtaining an inter-frame correlation between the current field signal S1 and the two-field delay signal S3. An output of the inter-frame difference absolute value circuit 25 is inputted to the small area integration circuit 27.

The small area integration circuit 26 integrates an inter-field difference absolute value outputted from the inter-field difference absolute value circuit 23 in a small area (area constituted of plural small pixels obtained by segmenting a field) unit (or a pixel unit), and output an inter-field difference value in a small area unit. The small area integration circuit 27 integrates an inter-frame difference absolute value outputted from the inter-frame difference absolute value circuit 25 in a small area unit, and outputs an inter-frame difference value in a small area unit. The output of the small area integration circuit 26 is inputted to an inter-field comparator 28, and the output of the small area integration circuit 27 is inputted to an inter-frame comparator 29. Incidentally, for the small area integration circuits 26, 27, a small area is set to a rectangular area with 8 horizontal pixels×8 vertical lines for example.

The inter-field comparator 28 is a first comparing device according to the present invention and compares the output of the small area integration circuit 26 with a threshold value E1 (a first difference value comparison threshold value). This threshold value E1 is set to a predetermined value capable of detecting an area that can be judged to be moving or to have larger motion (hereinafter referred to as “moving area”) in a small area unit. The inter-field comparator 28 outputs a signal (moving area signal) indicating detection of a moving area when the inter-field difference value outputted from the small area integration circuit 26 is equal to or above the threshold value E1.

The inter-frame comparator 29 is a second comparing device according to the present invention and compares the output of the small-area integration circuit 27 with a threshold value E2 (a second difference value comparison threshold value). This threshold value E2 is also set to a predetermined value capable of detecting a moving area in a small area unit. The inter-frame comparator 29 outputs a signal (moving area signal) indicating detection of a moving area when the inter-frame difference value outputted from the small area integration circuit 27 is equal to or above the threshold value E2.

The moving area signals outputted from the inter-field comparator 28 and the inter-frame comparator 29 are inputted to in-screen counters 30, 31 respectively.

The in-screen counter 30 is a first counting device and counts the number of moving area signals outputted from the inter-field comparator 28 and inputs a moving area count value indicating a result of counting to a small area inter-field comparator 32 and an inter-field accumulated value comparator 34. The in-screen counter 31 is a second counting device and counts the number of moving area signals outputted from the inter-frame comparator 29 and inputs a moving area count value indicating a result of counting to a small area inter-frame comparator 33 and an inter-frame accumulated value comparator 35.

The small area inter-field comparator 32 is a first field detecting device and compares the moving area count value outputted from the in-screen counter 30 in a small area unit with a threshold value E3 to detect a low correlation field (first low correlation field) having a low inter-field correlation. This threshold value E3 is set to a predetermined value capable of detecting a first low correlation field by comparison in a small area unit. The small area inter-field comparator 32 outputs a signal (first low correlation field signal) indicating detection of a first low correlation field when the moving area count value reaches or surpasses the threshold value E3, in other words, the number of moving areas (the number of moving areas is also referred to as “moving area number”) detected by the inter-field comparator 28 reaches or surpasses the threshold value E3.

The small area inter-frame comparator 33 is a second field detecting device and compares the moving area count value outputted from the in-screen counter 31 in a small area unit with the threshold value E4 to detect a low correlation field (second low correlation field) having a low inter-frame correlation. This threshold value E4 is set to a predetermined value capable of detecting a second low correlation field by comparison in a small area unit. The small area inter-frame comparator 33 outputs a signal (second low correlation field signal) indicating detection of a second low correlation field when the moving area count value reaches or surpasses the threshold value E4, in other words, the number of moving areas detected by the inter-frame comparator 29 reaches or surpasses the threshold value E4.

The inter-field accumulated value comparator 34 compares the moving area count value outputted from the in-screen counter 30 with a threshold value E5 in a field unit and outputs a signal indicating the comparison result thereof to an inter-field pattern detecting circuit 36. This threshold value E5 is set to a predetermined value capable of detecting a low correlation field having a low inter-field correlation in a field unit. Further, the inter-frame accumulated value comparator 35 compares the moving area count value outputted from the in-screen counter 31 with a threshold value E6 and outputs a signal indicating the comparison result thereof to an inter-frame pattern detecting circuit 37. This threshold value E6 is set to a predetermined value capable of detecting a low correlation field having a low inter-frame correlation in a frame unit.

The inter-field pattern detecting circuit 36 is a first pattern detecting device and detects based on a signal inputted from the inter-field accumulated value comparator 34 whether or not an inter-field correlation between plural fields such as sequential five fields for example matches a particular pattern of a pull-down signal such as 2-3 pull-down signal, 2-2 pull-down signal or the like, and outputs a signal indicating a detection result thereof. The inter-frame pattern detecting circuit 37 is a second pattern detecting device and detects based on a signal inputted from the inter-frame accumulated value comparator 35 whether or not an inter-frame correlation between plural fields such as sequential five fields matches a particular pattern of a pull-down signal, and outputs a signal indicating a detection result thereof.

A screen unit pull-down signal judgment circuit 38 is a field unit pull-down signal detecting device and performs the following judgment based on the signal outputted from the inter-field pattern detecting circuit 36 and the signal outputted from the inter-frame pattern detecting circuit 37. Specifically, the screen unit pull-down signal judgment circuit 38 judges whether an input video signal is a pull-down signal or not in a predetermined number of fields and outputs a screen unit pull-down signal detecting signal G3 which indicates a judgment result thereof. Further, the screen unit pull-down signal judgment circuit 38 outputs an inter-field correlation flag G1 indicating high or low of an inter-field correlation judged in a screen unit and an inter-frame correlation flag G2 indicating high or low of an inter-frame correlation judged in a screen unit. The screen unit pull-down signal detecting signal G3 indicates a detection result of a pull-down signal performed in a screen unit. Further, the screen unit pull-down signal judgment circuit 38 outputs the pair field selection signal K2 when the input video signal is a pull-down signal.

An inter-field pull-down signal judgment circuit 39 performs the following judgment based on the first low correlation field signal outputted from the small area inter-field comparator 32, the inter-field correlation flag G1 and the screen unit pull-down signal detecting signal G3.

The inter-field pull-down signal judgment circuit 39 judges whether or not the first low correlation field signal is outputted from the small area inter-field comparator 32 when an inter-field correlation is high in a screen unit and thus it is judged to be a high correlation field (the high correlation field judged at this time corresponds to a first high correlation field according to the present invention) in a state that the pull-down signal in a screen unit is detected. The inter-field pull-down signal judgment circuit 39 judges that the input video signal is not a pull-down signal when the first low correlation field signal is outputted, and outputs a pull-down signal detection signal H1 showing a judgment result thereof.

Further, since the first low correlation field signal is outputted when a moving area number between fields reaches or surpasses the threshold value E3, it turns out that the inter-field pull-down signal judgment circuit 39 carries out the above judgment based on the moving area number (first unit moving area number) between fields obtained in a small area unit for the first high correlation field.

An inter-frame pull-down signal judgment circuit 40 performs the following judgment based on the second low correlation field signal outputted from the small area inter-frame comparator 33, the inter-frame correlation flag G2 and the screen unit pull-down signal detecting signal G3.

The inter-frame pull-down signal judgment circuit 40 judges whether or not the second low correlation field signal is outputted from the small area inter-frame comparator 33 when an inter-frame correlation is high in a screen unit and thus it is judged to be a high correlation field (the high correlation field judged at this time corresponds to a second high correlation field according to the present invention) in a state that the pull-down signal in a screen unit is detected. The inter-frame pull-down signal judgment circuit 40 judges that the input video signal is not a pull-down signal when the second low correlation field signal is outputted, and outputs a pull-down signal detection signal H2 showing a judgment result thereof.

Further, since the second low correlation field signal is outputted when a moving area number between frames reaches or surpasses the threshold value E4, it turns out that the inter-frame pull-down signal judgment circuit 40 carries out the above judgment based on the moving area number (second unit moving area number) between frames obtained in a small area unit for the second high correlation field.

A pull-down signal judgment circuit 41 outputs the pull-down signal detection signal K1 based on the pull-down signal detection signals H1, H2 and the pull-down signal detecting signal G3. The pull-down signal detection signal K1 indicates that an input video signal is not a pull-down signal (or is a non-pull-down signal) when the first unit moving area number for the first high correlation field reaches or surpasses the threshold value E3, or the second unit moving area number for the second high correlation field reaches or surpasses the threshold value E4 in a state that the pull-down signal in a screen unit is detected. These inter-field pull-down signal judgment circuit 39, inter-frame pull-down signal judgment circuit 40 and pull-down signal judgment circuit 41 constitute a pull-down signal judging device according to the present invention.

Then, the pull-down signal detecting circuit 14 having the above configuration has the following characteristics. This point will be described with respect to FIG. 3.

In general, when an input video signal is a pull-down signal (FIG. 3 shows the case of 2-3 pull-down scheme), the current field signal S1, the one-field delay signal S2, and the one-frame delay signal S3 become as shown in FIG. 3. In FIG. 3, after the current field signal S1 continues as fields A_{E}, Ao, B_{E}, Bo, B_{E}, it switches to a normal video signal, and then fields C, D, E continue.

There are an inter-field correlation between the current field signal S1 and the one-field delay signal S2 and an inter-frame correlation between the current field signal S1 and the two-field delay signal (one-frame delay signal) S3.

Here, the case is assumed that the current field signal S1 is continuously a pull-down signal after a fourth field B_{E} at time T4. Then, with a case of low correlation being called dynamic (Dc) and a case of high correlation being called static (Sc) for both inter-field and inter-frame, inter-field correlations and inter-frame correlations from a second field B_{E} at time t2 to a sixth field Bo at time t6 should be as follows respectively. Specifically, the inter-field correlations should be Dc-Sc-Sc-Dc-Sc, and the inter-frame correlations should be Dc-Dc-Sc-Dc-Dc.

However, as shown in FIG. 3, the current field signal S1 is switched to a normal video signal from a fifth field C at time t5 (in this case, it is switched to the normal video signal after three fields B_{E}, Bo, B_{E}), so that the inter-frame correlation from the second field B_{E} at time t2 is Dc-Sc-Sc-Dc-Dc. Therefore, in the fifth field C at time t5, although it is switched from the pull-down signal to the normal video signal, timing when the inter-field correlation breaks is a sixth field D at time t6. In this case, judgment of switching from the pull-down signal to the normal video signal occurs at the sixth field D, and thus a deviation is generated in the timing of the judgment of switching.

Accordingly, in the progressive scan converting circuit 1, timing of performing a motion adaptive interpolation deviates. Then, selection of the motion adaptive interpolation signal S5 by the second selector 16 to output the interpolation signal S6 occurs in a seventh field at time t7 or thereafter. Also, at time t6, the pair field selection signal K2 is outputted, and the interpolation signal S6 for which the pair field signal S4 is selected is outputted, so that wrong pull-down processing (combining processing of corresponding fields) is performed for the field C in the sixth field and the sixth field D (in this embodiment, the wrong pull-down processing is also referred to as erroneous interpolation). When this erroneous interpolation is performed, noise in a comb shape is generated.

However, in the progressive scan converting circuit 1 according to the present invention, since the pull-down signal is detected by the pull-down signal detecting circuit 14 configured as above, it is possible to reduce generation of the noise in a comb shape as will be described later even when switching from a 2-3 pull-down scene to a normal video scene.

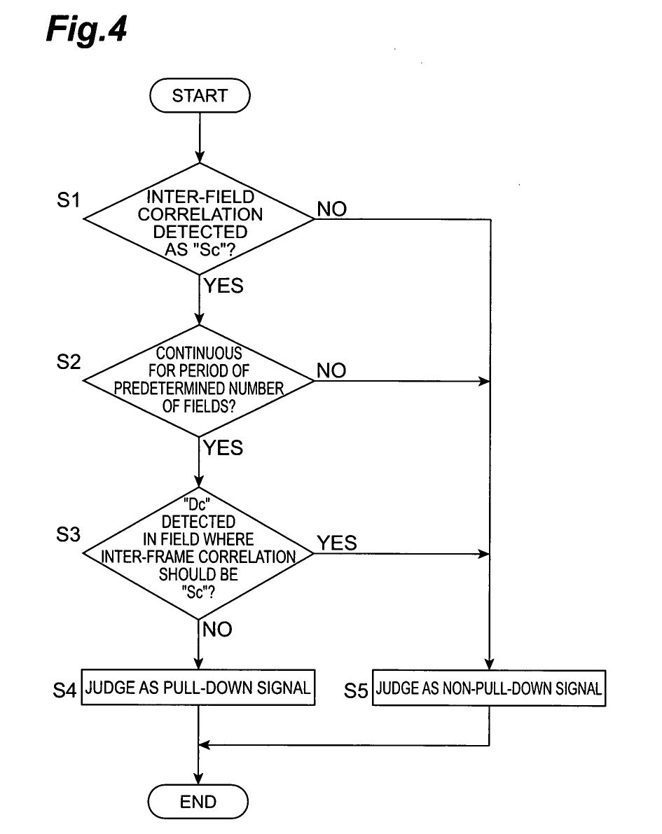

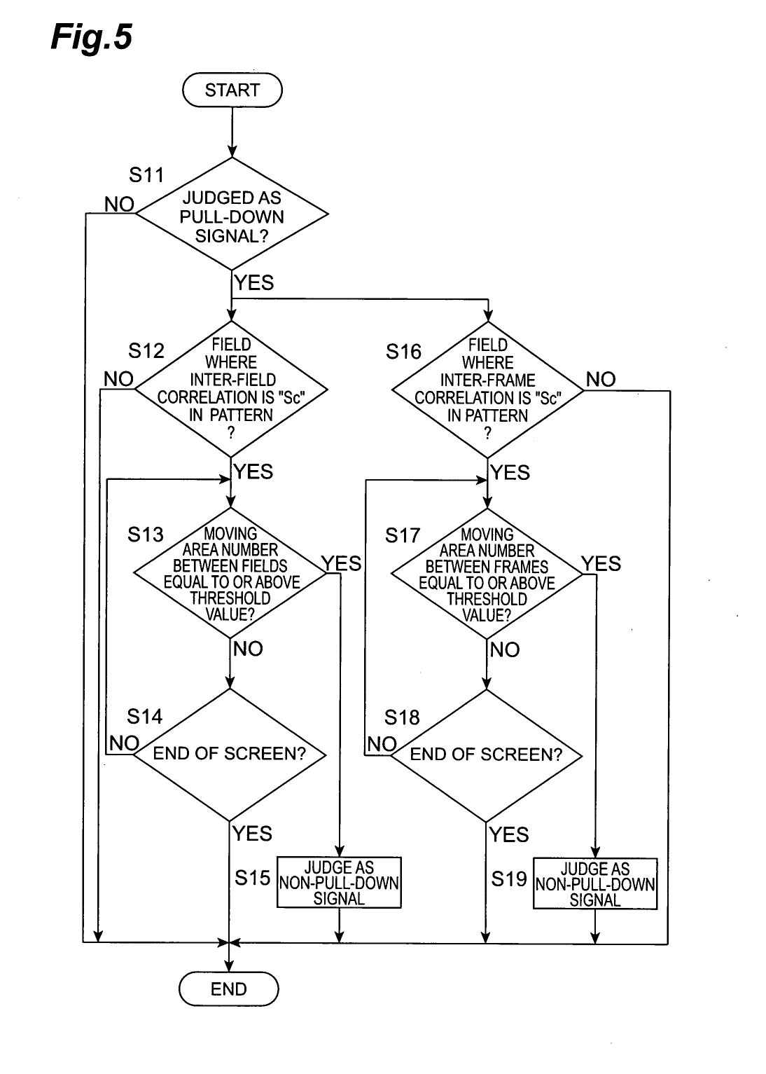

Hereinafter, referring to flowcharts shown in FIG. 4 and FIG. 5, a detection procedure of a pull-down signal with the pull-down signal detecting circuit 14 will be described in more detail. Here, FIG. 4 is a flowchart showing a detection procedure of a pull-down signal in a screen unit with the pull-down signal detecting circuit 14, and FIG. 5 is a flowchart showing a detection procedure of a pull-down signal by detecting a moving area number in a small area unit with the pull-down signal detecting circuit 14. Note that in FIG. 4 and FIG. 5, block is abbreviated to “S”.

As shown in FIG. 4, the pull-down signal detecting circuit 14 judges whether an inter-field correlation is detected to be “Sc” or not in block 1. Here, the pull-down signal detecting circuit 14 proceeds to block 2 when it is detected to be “Sc”, or it proceeds to block 5 when it is not detected to be “Sc.

When proceeding to block 2, the pull-down signal detecting circuit 14 judges whether it is sequential or not for the period of a predetermined number of fields. Here, the pull-down signal detecting circuit 14 proceeds to block 3 when it is sequential, or it proceeds to block 5 when it is not sequential.

When proceeding to block 3, the pull-down signal detecting circuit 14 judges whether an inter-frame correlation is detected to be “Dc” or not in a field where it should be “Sc”. The pull-down signal detecting circuit 14 proceeds to block 5 when it is detected to be “Dc”, or it proceeds to block 4 when it is not detected to be “Dc”.

Then, the pull-down signal detecting circuit 14 judges that it is a pull-down signal in block 4, or judges that it is a non-pull-down signal in block 5, and thereafter completes the detection of a pull-down signal in a screen unit.

Meanwhile, the pull-down signal detecting circuit 14 executes block 12 and thereafter of the detection procedure of a pull-down signal shown in FIG. 5 when a pull-down signal is detected (in this case, when the screen unit pull-down signal detecting signal G3 indicates a pull-down signal) in a screen unit in the flowchart shown in FIG. 4. Note that in FIG. 5, in relation to the parallel configuration of the circuits for performing inter-field processing from the inter-field difference absolute value circuit 23 to the inter-field pattern detecting circuit 36 and the circuits for performing inter-frame processing from the inter-frame difference absolute value circuit 25 to the inter-frame pattern detecting circuit 37, steps 12 to 15 and steps 16 to 19 are shown in parallel.

When starting the detection procedure of a pull-down signal shown in FIG. 5, the pull-down signal detecting circuit 14 judges whether a pull-down signal is detected or not in a screen unit in block 11, and when the pull-down signal is detected in a screen unit, it proceeds to blocks 12, 16, or otherwise terminates the process. When proceeding to block 12, the pull-down signal detecting circuit 14 judges whether or not it is a field where an inter-filed correlation is “Sc” (the above-described first high correlation field, for example the sixth field C shown in FIG. 3) on the pull-down sequence, and then terminates the process if it is not “Sc” field.

The pull-down signal detecting circuit 14 proceeds to block 13 when it is a field where an inter-field correlation is “Sc” in block 12, or otherwise terminates the process. The pull-down signal detecting circuit 14 judges whether the moving area number between fields is equal to or above the threshold value E3 in block 13.

Further, the pull-down signal detecting circuit 14 proceeds to block 15 when it is judged in step 13 that the moving area number between fields is equal to or above the threshold value E3 to judge it as a non-pull-down signal and terminates the process, or otherwise proceeds to block 14. When proceeding to block 14, the pull-down signal detecting circuit 14 judges whether it is the end of a screen or not, and returns the process to block 13 to repeat it when it is not the end of a screen, or otherwise terminates the process.

The pull-down signal detecting circuit 14 performs the same process for an inter-frame correlation. Specifically, the pull-down signal detecting circuit 14 judges in block 16 whether or not it is a field where an inter-frame correlation is “Sc” (the above-described second high correlation field) on the pull-down sequence. Here, when it is a field of “Sc”, the pull-down signal detecting circuit 14 proceeds to block 17 to judge whether the moving area number between frames is equal to or above the threshold value E4, or otherwise terminates the process.

Further, the pull-down signal detecting circuit 14 proceeds to block 19 when it is judged in block 17 that the moving area number between frames is equal to or above the threshold value E4 to judge it as a non-pull-down signal and terminates the process, or otherwise proceeds to block 18. When proceeding to block 18, the pull-down signal detecting circuit 14 judges whether it is the end of a screen or not, and returns the process to block 17 to repeat it when it is not the end of a screen, or otherwise terminates the process.

Further, when the pull-down signal detecting circuit 14 executed blocks 15, 19, the pull-down signal detection signal K1 indicates that it is a non-pull-down signal.

As above, the pull-down signal detecting circuit 14 is capable of judging as a non-pull-down signal with either the first high correlation field or the second high correlation field when the moving area number between fields reaches or surpass the threshold value E3 or the moving area number between frames reaches or surpasses the threshold value E4. Accordingly, the pull-down signal detecting circuit 14 is capable of judging as a non-pull-down signal even when it is in middle of a screen. Then, the second selector 16 selects the motion adaptive interpolation signal S5. Therefore, the progressive scan converting circuit 1 having this pull-down signal detecting circuit 14 is capable of stopping the progressive scanning conversion by means of the pull-down processing (corresponding field combination) even in middle of a screen to switch to the progressive scanning conversion by means of the motion adaptive interpolation. Therefore, it is possible to reduce generation of noise in a comb shape when switching from a 2-3 pull-down scene to a normal video scene as shown in FIG. 3.

The above operation being a characteristic of the present invention in the pull-down signal detecting circuit 14 is described in accordance with the flowcharts shown in FIG. 4 and FIG. 5. Besides that, equivalent functions to those of the pull-down signal detecting circuit 14 may be realize by providing an MPU (Micro Processing Unit) and a ROM (Read Only Memory) in the progressive scan converting circuit 1, and performing control by the MPU in accordance with the flowcharts shown in FIG. 4 and FIG. 5 according to a program stored in the ROM.

The above explanation is for the embodiment of the present invention and is not to limit the apparatus and method according to the present invention, and various modification examples can be simply implemented. Further, any device or method configured by appropriately combining components, functions, characteristics or method steps in each embodiment is included in the present invention.

As described in detail above, according to the present invention, the pull-down signal detecting apparatus and the pull-down signal detecting method and the progressive scan converting apparatus and the progressive scan converting method which are capable of reducing generation of noise in a comb shape when switching from a pull-down signal to a normal video signal can be obtained.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A pull-down signal detecting apparatus for detecting a pull-down signal using three field signals, a current field signal that is an input video signal, a one-field delay signal generated by delaying the current field signal by one field and a two-field delay signal generated by delaying the one-field delay signal by one field, said device comprising
a pull-down signal judging device for judging whether the input video signal is the pull-down signal or not based on a first unit moving area number obtained in a small area unit for a first high correlation field having a high inter-field correlation between the current field signal and the one-field delay signal, or a second unit moving area number obtained in a small area unit for a second high correlation field having a high inter-frame correlation between the current field signal and the two-field delay signal.

2. The pull-down signal detecting apparatus according to claim 1, further comprising
a field unit pull-down signal detecting device for detecting the pull-down signal in a field unit from the input video signal,
wherein when the pull-down signal is detected in a field unit by said field unit pull-down signal detecting device, said pull-down signal judging device judges whether the input video signal is the pull-down signal or not.

3. The pull-down signal detecting apparatus according to claim 1, further comprising
a field unit pull-down signal detecting device for detecting the pull-down signal in a field unit from the input video signal,
wherein when the pull-down signal is detected in a field unit by said field unit pull-down signal detecting device, said pull-down signal judging device judges that the input video signal is not the pull-down signal when the first unit moving area number reaches or surpasses a threshold value or when the second unit moving area number reaches or surpasses a threshold value.

4. The pull-down signal detecting apparatus according to claim 1, further comprising:
a first field detecting device for detecting a first low correlation field having a low inter-field correlation based on a moving area number in a small area unit between fields for each field of the current field signal and the one-field delay signal; and
a second field detecting device for detecting a second low correlation field having a low inter-frame correlation based on a moving area number in a small area unit between frames for each field of the current field signal and the two-field delay signal,
wherein said pull-down signal judging device judges whether the input video signal is the pull-down signal or not based on an output of said first field detecting device and an output of said second field detecting device.

5. The pull-down signal detecting apparatus according to claim 2, further comprising:
a first field detecting device for detecting a first low correlation field having a low inter-field correlation based on a moving area number in a small area unit between fields for each field of the current field signal and the one-field delay signal; and
a second field detecting device for detecting a second low correlation field having a low inter-frame correlation based on a moving area number in a small area unit between frames for each field of the current field signal and the two-field delay signal,
wherein said pull-down signal judging device judges whether the input video signal is the pull-down signal or not based on an output of said first field detecting device and an output of said second field detecting device.

6. The pull-down signal detecting apparatus according to claim 3, further comprising:
a first field detecting device for detecting a first low correlation field having a low inter-field correlation based on a moving area number in a small area unit between fields for each field of the current field signal and the one-field delay signal; and
a second field detecting device for detecting a second low correlation field having a low inter-frame correlation based on a moving area number in a small area unit between frames for each field of the current field signal and the two-field delay signal,
wherein said pull-down signal judging device judges whether the input video signal is the pull-down signal or not based on an output of said first field detecting device and an output of said second field detecting device.

7. The pull-down signal detecting apparatus according to claim 4, further comprising:
a first difference value calculating device for calculating an inter-field difference value between the current field signal and the one-field delay signal in a small area unit; and
a second difference value calculating device for calculating an inter-frame difference value between the current field signal and the two-field delay signal in a small area unit,
wherein said first field detecting device detects the first low correlation field based on the inter-field difference value calculated by said first difference value calculating device, and said second field detecting device detects the second low correlation field based on the inter-frame difference value calculated by said second difference value calculating device.

8. The pull-down signal detecting apparatus according to claim 5, further comprising:
a first difference value calculating device for calculating an inter-field difference value between the current field signal and the one-field delay signal in a small area unit; and
a second difference value calculating device for calculating an inter-frame difference value between the current field signal and the two-field delay signal in a small area unit,
wherein said first field detecting device detects the first low correlation field based on the inter-field difference value calculated by said first difference value calculating device, and said second field detecting device detects the second low correlation field based on the inter-frame difference value calculated by said second difference value calculating device.

9. The pull-down signal detecting apparatus according to claim 6, further comprising:
a first difference value calculating device for calculating an inter-field difference value between the current field signal and the one-field delay signal in a small area unit; and
a second difference value calculating device for calculating an inter-frame difference value between the current field signal and the two-field delay signal in a small area unit,
wherein said first field detecting device detects the first low correlation field based on the inter-field difference value calculated by said first difference value calculating device, and said second field detecting device detects the second low correlation field based on the inter-frame difference value calculated by said second difference value calculating device.

10. The pull-down signal detecting apparatus according to claim 4, further comprising:
a first difference value calculating device for calculating an inter-field difference value between the current field signal and the one-field delay signal in a small area unit;
a second difference value calculating device for calculating an inter-frame difference value between the current field signal and the two-field delay signal in a small area unit;
a first comparing device for comparing the inter-field difference value calculated by said first difference value calculating device with a first difference value comparison threshold value set to be capable of detecting a moving area in a small area unit to thereby output a moving area signal indicating detection of a moving area;
a second comparing device for comparing the inter-frame difference value calculated by said second difference value calculating device with a second difference value comparing threshold value set to be capable of detecting a moving area in a small area unit to thereby output a moving area signal indicating detection of a moving area;
a first counting device for counting the number of moving area signals outputted from said first comparing device; and
a second counting device for counting the number of moving area signals outputted from said second comparing device,
wherein said first field detecting device detects the first low correlation field based on a count value of said first counting device, and said second field detecting device detects the second low correlation field based on a count value of said second counting device.

11. The pull-down signal detecting apparatus according to claim 5, further comprising:
a first difference value calculating device for calculating an inter-field difference value between the current field signal and the one-field delay signal in a small area unit;
a second difference value calculating device for calculating an inter-frame difference value between the current field signal and the two-field delay signal in a small area unit;
a first comparing device for comparing the inter-field difference value calculated by said first difference value calculating device with a first difference value comparison threshold value set to be capable of detecting a moving area in a small area unit to thereby output a moving area signal indicating detection of a moving area;
a second comparing device for comparing the inter-frame difference value calculated by said second difference value calculating device with a second difference value comparing threshold value set to be capable of detecting a moving area in a small area unit to thereby output a moving area signal indicating detection of a moving area;
a first counting device for counting the number of moving area signals outputted from said first comparing device; and
a second counting device for counting the number of moving area signals outputted from said second comparing device,
wherein said first field detecting device detects the first low correlation field based on a count value of said first counting device, and said second field detecting device detects the second low correlation field based on a count value of said second counting device.

12. The pull-down signal detecting apparatus according to claim 6, further comprising:
a first difference value calculating device for calculating an inter-field difference value between the current field signal and the one-field delay signal in a small area unit;
a second difference value calculating device for calculating an inter-frame difference value between the current field signal and the two-field delay signal in a small area unit;
a first comparing device for comparing the inter-field difference value calculated by said first difference value calculating device with a first difference value comparison threshold value set to be capable of detecting a moving area in a small area unit to thereby output a moving area signal indicating detection of a moving area;
a second comparing device for comparing the inter-frame difference value calculated by said second difference value calculating device with a second difference value comparing threshold value set to be capable of detecting a moving area in a small area unit to thereby output a moving area signal indicating detection of a moving area;
a first counting device for counting the number of moving area signals outputted from said first comparing device; and
a second counting device for counting the number of moving area signals outputted from said second comparing device,
wherein said first field detecting device detects the first low correlation field based on a count value of said first counting device, and said second field detecting device detects the second low correlation field based on a count value of said second counting device.

13. The pull-down signal detecting apparatus according to claim 2, further comprising:
a first pattern detecting device for detecting whether an inter-field correlation between plural fields of the current field signal and the one-field delay signal matches a specific pattern of the pull-down signal or not; and
a second pattern detecting device for detecting whether an inter-frame correlation between plural fields of the current field signal and the two-field delay signal matches a specific pattern of the pull-down signal or not,
wherein said field unit pull-down signal detecting device detects the pull-down signal in a field unit based on outputs of said first pattern detecting device and said second pattern detecting device.

14. The pull-down signal detecting apparatus according to claim 3, further comprising:
a first pattern detecting device for detecting whether an inter-field correlation between plural fields of the current field signal and the one-field delay signal matches a specific pattern of the pull-down signal or not; and
a second pattern detecting device for detecting whether an inter-frame correlation between plural fields of the current field signal and the two-field delay signal matches a specific pattern of the pull-down signal or not,
wherein said field unit pull-down signal detecting device detects the pull-down signal in a field unit based on outputs of said first pattern detecting device and said second pattern detecting device.

15. The pull-down signal detecting apparatus according to claim 4, further comprising:
a first pattern detecting device for detecting whether an inter-field correlation between plural fields of the current field signal and the one-field delay signal matches a specific pattern of the pull-down signal or not; and
a second pattern detecting device for detecting whether an inter-frame correlation between plural fields of the current field signal and the two-field delay signal matches a specific pattern of the pull-down signal or not,
wherein said field unit pull-down signal detecting device detects the pull-down signal in a field unit based on outputs of said first pattern detecting device and said second pattern detecting device.

16. The pull-down signal detecting apparatus according to claim 7, further comprising:
a first pattern detecting device for detecting whether an inter-field correlation between plural fields of the current field signal and the one-field delay signal matches a specific pattern of the pull-down signal or not; and
a second pattern detecting device for detecting whether an inter-frame correlation between plural fields of the current field signal and the two-field delay signal matches a specific pattern of the pull-down signal or not,
wherein said field unit pull-down signal detecting device detects the pull-down signal in a field unit based on outputs of said first pattern detecting device and said second pattern detecting device.

17. The pull-down signal detecting apparatus according to claim 10, further comprising:
a first pattern detecting device for detecting whether an inter-field correlation between plural fields of the current field signal and the one-field delay signal matches a specific pattern of the pull-down signal or not; and
a second pattern detecting device for detecting whether an inter-frame correlation between plural fields of the current field signal and the two-field delay signal matches a specific pattern of the pull-down signal or not,
wherein said field unit pull-down signal detecting device detects the pull-down signal in a field unit based on outputs of said first pattern detecting device and said second pattern detecting device.

18. A pull-down signal detecting method for detecting a pull-down signal using three field signals, a current field signal that is an input video signal, a one-field delay signal generated by delaying the current field signal by one field and a two-field delay signal generated by delaying the one-field delay signal by one field, said method comprising
detecting the pull-down signal by judging whether the input video signal is the pull-down signal or not based on a first unit moving area number obtained in a small area unit for a first high correlation field having a high inter-field correlation between the current field signal and the one-field delay signal, or a second unit moving area number obtained in a small area unit for a second high correlation field having a high inter-frame correlation between the current field signal and the two-field delay signal.

19. A progressive scan converting apparatus for generating a progressive scan converting signal using three field signals, a current field signal that is an input video signal, a one-field delay signal generated by delaying the current field signal by one field and a two-field delay signal generated by delaying the one-field delay signal by one field, said apparatus comprising:
a pull-down signal detecting apparatus comprising a pull-down signal judging device for judging whether the input video signal is the pull-down signal or not based on a first unit moving area number obtained in a small area unit for a first high correlation field having a high inter-field correlation between the current field signal and the one-field delay signal, or a second unit moving area number obtained in a small area unit for a second high correlation field having a high inter-frame correlation between the current field signal and the two-field delay signal;
an interpolation signal generating device for generating a first interpolation signal from the current field signal, the one-field delay signal and the two-field delay signal;
a first selector for selecting one of the current field signal and the two-field delay signal based on an output of said pull-down signal detecting apparatus to thereby output the selected signal as a pair field signal;
a second selector for selecting one of the first interpolation signal and the pair field signal based on an output of said pull-down signal detecting apparatus to thereby output a second interpolation signal; and
a scanning line arranging device for arranging the first field delay signal and the second interpolation signal to thereby output a progressive scan converting signal.
